(19) United States
(12) Patent Application Publication
(10) Pub. No.: US 2008/0258016 A1
(43) Pub. Date: Oct. 23, 2008

(54) NACELLE ASSEMBLY WITHOUT LOWER BI-FI SPLITTER

(76) Inventors: Robert L. Gukeisen, Middletown, CT (US); Richard M. Marshall, West Granby, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/738,607

(22) Filed: Apr. 23, 2007

(51) Int. Cl. B64D 29/00; B64C 1/14

(52) U.S. Cl. 244/53 R; 244/129.5

(57) ABSTRACT

A nacelle assembly provides thrust reverser doors and core cowl doors with separate thrust reverser door hinge lines and core cowl doors hinge lines for independent operation to eliminate the requirement of a lower bi-fi splitter. The removal of the lower Bi-Fi splitter provides improved aerodynamic packaging with improved performance by reducing drag in the bypass fan stream.

### BACKGROUND OF THE INVENTION

The present invention relates to aircraft engine nacelles, and more particularly to aircraft engine nacelles having thrust reverser cowl doors and core cowl doors which are independently hinged to eliminate a lower bi-fi splitter.

Gas turbine engines are mounted on an aircraft by a support structure such as a pylon. A nacelle arrangement encloses the engine forming a shelter which is aerodynamically contoured to reduce drag. The nacelle arrangement is supported in part from the pylon and in part from the engine.

Conventional nacelle arrangements include a removable metal and or composite cowling. The cowling includes a fan duct reverser cowl and a core cowl. The larger diameter fan duct reverser cowl and the smaller diameter core cowl are interconnected by a bi-fi wall. Although the bi-fi provides additional stiffness for the nacelle, the bi-fi splitter may partially block the bypass fan stream and reduce engine efficiency.

Accordingly, it is desirable to provide an engine nacelle arrangement which minimizes engine bypass fan steam flow.

### SUMMARY OF THE INVENTION

The nacelle assembly according to the present invention includes separately movable fan cowl doors, thrust reverser doors, and core cowl doors. The thrust reverser doors and core cowl doors have separate thrust reverser door hinge lines and core cowl door hinge lines for independent operation to eliminate the requirement of a lower bi-fi splitter. The removal of the lower Bi-Fi splitter provides improved aerodynamic packaging with improved performance by reducing drag in the bypass fan stream.

The present invention therefore provides an engine nacelle arrangement which minimizes engine bypass fan steam flow.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1A is a general isometric view of a nacelle with a fan cowl door in the open position;

FIG. 1B is a general isometric view of a nacelle with a fan cowl door and a thrust reverser door in the open position;

FIG. 1C is a general isometric view of a nacelle with a fan cowl door, a thrust reverser door, and a core cowl door in the open position; and

FIG. 2 is a side view of a nacelle illustrating the hinge line of each door.

### DETAILED DESCRIPTION OF THE DISCLOSED EMBODIMENT

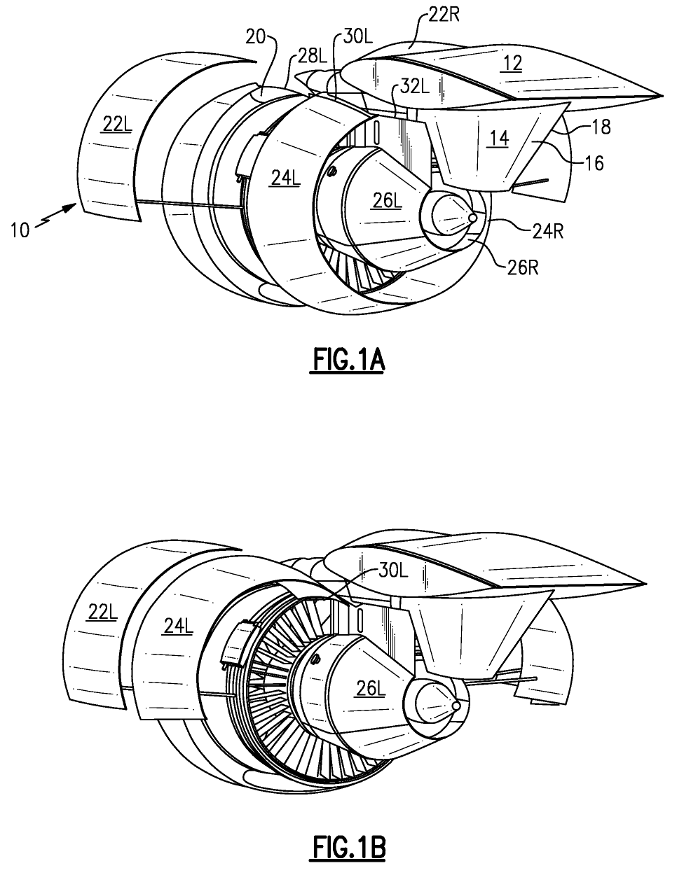

FIGS. 1A-1C schematically illustrates a gas turbine engine 10 of the axially flow, turbo fan type. Wing 12 of an aircraft includes a pylon or other support structure 14 which engages the engine 10. The pylon 14 has a first side 16 and a second side 18. A nacelle assembly 20 is mounted to the pylon 14 to circumscribe the engine 10 to support and position the engine 10 relative the aircraft wing 12.

The nacelle assembly 20 includes separately movable fan cowl doors 22L, 22R, thrust reverser doors 24L, 24R, and core cowl doors 26L, 26R. The core cowl doors 26L, 26R are located at least partially radially within the thrust reverser doors 24L, 24R. Each of the fan cowl doors 22L, 22R, thrust reverser doors 24L, 24R, and core cowl doors 26L, 26R are defined to hinge about a respective hinge line 28L, 28R, 30L, 30R, and 32L, 32R. It should be understood that the fan cowl door 22, the thrust reverser door 24, and the core cowl door 26 include both left hand (LH) and right hand (RH) clam shell-type doors which each include a respective hinge. It should be understood that various locking mechanism may be utilized with each of the separately movable fan cowl doors 22L, 22R, thrust reverser doors 24L, 24R, and core cowl doors 26L, 26R which need not be described in detail herein.

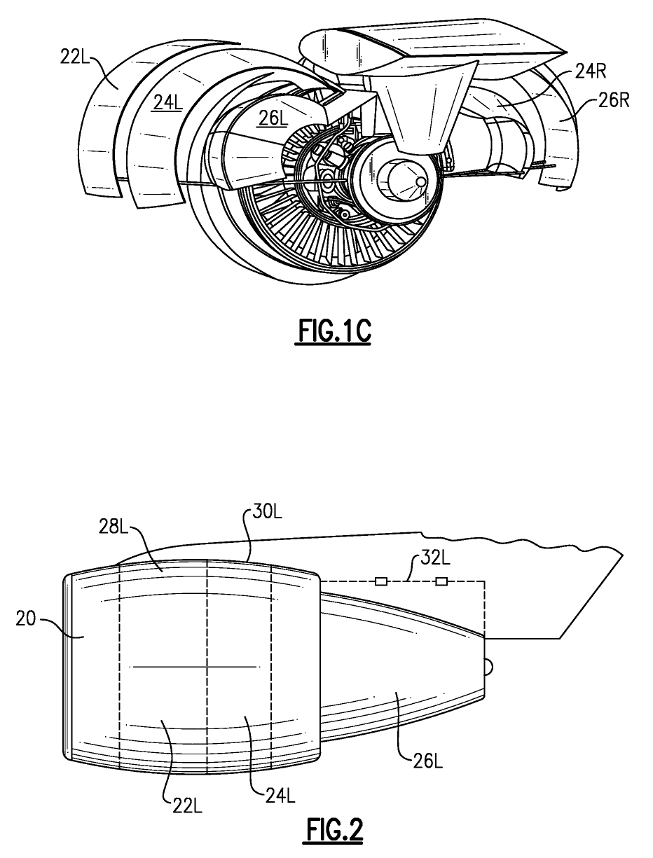

The clam shell-type fan cowl doors 22L, 22R, thrust reverser doors 24L, 24R, and core cowl doors 26L, 26R open around their respective hinge lines 28L, 28R, 30L, 30R, and 32L, 32R. The core cowl doors hinge lines 32L, 32R are separate from the thrust reverser door hinge lines 30L, 30R (FIG. 2) such that the thrust reverser doors 24L, 24R and the core cowl doors 26L, 26R may be opened separately. Due to the radially internal location, the thrust reverser doors 24L, 24R must be opened prior to opening of the core cowl doors 26L, 26R.

As the thrust reverser doors 24L, 24R and the core cowl doors 26L, 26R, separate the thrust reverser door hinge lines 30L, 30R from the core cowl doors hinge lines 32L, 32R the independent operation eliminates the requirement for a lower bi-fi splitter. The removal of the lower bi-fi splitter provides improved aerodynamic packaging with improved performance by reducing drag in the bypass fan stream. Service lines and the like which were routed through the lower bi-fi splitter are now routed through the upper bi-fi splitter 34. Although conventional blocker door thrust reverser systems may not be utilized with this door opening system, other thrust reverser systems such as pivot door systems may be utilized herewith.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A nacelle arrangement comprising:
a thrust reverser door which pivots about a thrust reverser door hinge axis; and
a core cowl door which pivots about a core cowl hinge axis, said core cowl hinge axis separate from said thrust reverser door hinge axis.

2. The nacelle arrangement as recited in claim 1, wherein said core cowl door is separate from said thrust reverser door.

3. The nacelle arrangement as recited in claim 1, wherein said core cowl door is at least partially radially within said thrust reverser door.

4. The nacelle arrangement as recited in claim 1, wherein said core cowl hinge axis is located along a side of a pylon which supports said nacelle arrangement.

5. The nacelle arrangement as recited in claim 1, wherein said core cowl door defines an upper bi-fi splitter.

6. A nacelle arrangement comprising:
a fan cowl door which pivots about a fan cowl door hinge axis;
a thrust reverser door which pivots about a thrust reverser door hinge axis, said fan cowl door axially aft of said thrust reverser door; and
a core cowl door which pivots about a core cowl hinge axis, said core cowl hinge axis separate from said thrust reverser door hinge axis.

7. The nacelle arrangement as recited in claim 6, wherein said core cowl door is at least partially radially within said thrust reverser door.

8. The nacelle arrangement as recited in claim 6, wherein said core cowl hinge axis is located along a side of a pylon which supports said nacelle arrangement.

9. The nacelle arrangement as recited in claim 6, wherein said core cowl door defines an upper bi-fi splitter.

10. The nacelle arrangement as recited in claim 9, wherein said bi-fi splitter extends radially between an engine pylon and said core cowl door.

11. A nacelle arrangement comprising:
a RH fan cowl door which pivots about a RH fan cowl door hinge axis;
a LH fan cowl door which pivots about a LH fan cowl door hinge axis;
a RH thrust reverser door which pivots about a RH thrust reverser door hinge axis, said RH fan cowl door axially aft of said RH thrust reverser door;
a LH thrust reverser door which pivots about a LH thrust reverser door hinge axis, said LH fan cowl door axially aft of said LH thrust reverser door;
a RH core cowl door which pivots about a RH core cowl hinge axis, said RH core cowl hinge axis separate from said RH thrust reverser door hinge axis; and
a LH core cowl door which pivots about a LH core cowl hinge axis, said LH core cowl hinge axis separate from said LH thrust reverser door hinge axis.
